(19) United States
(12) Patent Application Publication
(10) Pub. No.: US 2013/0280538 A1
(43) Pub. Date: Oct. 24, 2013

(54) METHOD AND DEVICE FOR APPLYING LIQUID REACTION MIXTURES TO A COVER LAYER

(71) Applicants: Michael Thater, Goldenstedt (DE); Ansgar Schmit, Osnabrueck (DE)

(72) Inventors: Michael Thater, Goldenstedt (DE); Ansgar Schmit, Osnabrueck (DE)

(73) Assignee: BASF SE, Ludwigshafen (DE)

(21) Appl. No.: 13/977,977

(22) PCT Filed: Jan. 4, 2012
(86) PCT No.: PCT/EP2012/050070

§ 371 Date: Jul. 2, 2013

(30) Foreign Application Priority Data
Jan. 7, 2011 (DE) 20 2011 001 109.7

(51) Int. Cl. B05C 5/00

(52) U.S. Cl. CPC B05C 5/00
USPC 428/425.8

(57) ABSTRACT

The invention relates to a device for applying liquid reaction mixtures to a cover layer, the cover layer being moved continuously and the liquid reaction mixture being applied to the cover layer, the device consisting of at least one pipe (a) which is preferably immovably arranged and which is provided with openings (b) in the direction of the cover layer, and which is mounted above the cover layer parallel to the cover layer plane and at a right angle to the direction of motion of the cover layer, the outer openings being located on the side of the pipe that is above the edge of the cover layer, at an angle of 1 to 50° in the direction of the edge of the cover layer. The invention further relates to the use of said device to produce composite elements and to apply liquid reaction mixtures to a cover layer. The invention further relates to a method for producing composite elements, comprising the application of liquid reaction mixtures to a cover layer by means of said device, the cover layer being moved continuously and the liquid reaction mixture being applied to the cover layer.

The invention relates to a device for applying liquid reaction mixtures to an outer layer, the outer layer being continuously moved and the liquid reaction mixture being applied to the outer layer, said device comprising at least one pipe a), which is preferably immovably arranged, and which is provided with openings b) in the direction of the outer layer, and which is provided above the outer layer parallel to the plane of the outer layer and at right angles to the direction of movement of the outer layer, the outer openings on the side of the pipe that is located over the edge of the outer layer being provided at an angle of 1 to 50° in the direction of the edge of the outer layer.

The present invention also relates to the use of said device for producing composite elements and for applying liquid reaction mixtures to an outer layer. The invention also relates to a method for producing composite elements comprising the application of liquid reaction mixtures to an outer layer by means of said device, the outer layer being continuously moved and the liquid reaction mixture being applied to the outer layer.

The production of composite elements from, in particular, metallic outer layers and a core of isocyanate-based foam materials, usually polyurethane (PUR) or polyisocyanurate (PIR) foam materials, together referred to hereafter just as PU foams, often also known as sandwich elements, on continuously operating twin-belt installations is currently carried out on a large scale. In addition to sandwich elements for the insulation of cold stores, elements for forming facades of a wide variety of buildings are growing in importance. Sectional doors are also increasingly being produced from sandwich elements. Apart from coated steel plates, stainless-steel, copper or aluminum plates are also used as outer layers.

The process proceeds by first the liquid starting components of the foam, in the production of isocyanate-based foams the polyol component and the isocyanate component, being mixed, for example in a mixing head, and applied from there by means of an applicator to the outer layer, where they react with one another while foaming and set to form the foam. Perforated pipes provided over the outer layer in such a way that the wetting of the outer layer can take place optimally are usually used as applicators. These pipes may also be referred to hereafter as casting rakes or simply as rakes.

The applicator may in this case be movably provided over the outer layer and the reaction mixture applied to the entire surface area of the outer layer by an oscillating movement.

Recently, pipes that are fixedly provided over the outer layer have also been used. Such devices are described, for example, in WO 2009/077490, in WO 2008/104492 or in WO 2008/018787.

The devices are usually made of metal, preferably of steel. Such devices are mechanically very stable, but must be laboriously cleaned when they become soiled, as occurs in particular as a result of caking on of reacted polyurethanes.

DE 202009015838.1 also describes applicators made of plastic, which can be replaced and disposed of when caked-on deposits occur. This allows the downtimes of the installations to be reduced.

It has been found that, with the usual applicators, application of the reaction mixture is often unsatisfactory at the edges of the outer layer. This is the case especially if the lower outer layer has a complicated profiling. With these profilings there occurs a dead space, in which no reaction mixture can be introduced from above. If the applicators end too close to the edges of the outer layer, reaction mixture may land alongside the outer layer, which can lead to product losses and soiling of the installation. If, to avoid this disadvantage, the applicators are provided in such a way that they end a relatively great distance from the edges of the outer layer, too little reaction mixture may arrive at the edges, which may lead to problems in terms of quality.

It was an object of the invention to improve the process for producing composite elements from, in particular, metallic outer layers and a core of PU foams and a more uniform distribution with which, even in the case of profiled lower outer layers, reaction mixture can be applied directly in dead regions. In particular, a uniform distribution of the liquid starting compounds of the PU foams on the outer layer and good quality of the resultant composite elements should be achieved.

It has surprisingly been found that the object can be achieved by providing the openings on the applicator that are located over the edge of the outer layer at an angle of 1 to 50° in the direction of the edge of the outer layer.

Accordingly, the subject matter of the invention is a device for applying liquid reaction mixtures to an outer layer, the outer layer being continuously moved and the liquid reaction mixture being applied to the outer layer, said device comprising at least one pipe a) which is preferably immovably arranged, and which is provided with openings b) in the direction of the outer layer, and which is provided above the outer layer parallel to the plane of the outer layer and at right angles to the direction of movement of the outer layer, wherein the outer openings on the side of the pipe that is located over the edge of the outer layer are provided at an angle of 1 to 50° in the direction of the edge of the outer layer.

In a preferred embodiment of the invention, the outer 1 to 4 openings b), which are located above the edge of the outer layers, are provided at an angle of 1 to 50° in the direction of the edge of the outer layer.

The feeding in of the liquid reaction mixture preferably takes place in the middle of the pipe a). In principle, the reaction mixing may also take place at one end of the pipe. This embodiment is not preferred, since there may in this case be an excessive buildup of pressure inside the pipe.

If the feeding in of the liquid reaction mixture takes place in the middle of the pipe a), the openings b) may be arranged symmetrically or unsymmetrically. A symmetrical arrangement means that the openings b) are arranged identically on both sides of the feed, that is to say the same number of openings b) are present on each side and are respectively at the same distance from the middle.

In the case of an unsymmetrical arrangement of the openings b), the openings b) are provided differently on the two sides of the feed. Preferably, in this case only the openings b) that are provided at an angle differ from one another. This embodiment is used in particular whenever the edges of the outer layer have different contours. In this case, one, two, three or four openings b) may be provided on both sides, differently from one another, from 1 to 50° in the direction of the edge of the outer layer. With this embodiment, even complicated contours at the edges of the outer layers can be provided with foam. Thus, in one embodiment, the applicator may have one opening b) on one side and three openings b) on the other side.

In this embodiment, the applicator is no longer symmetrical, as stated above, and consequently discharges the reaction mixtures non-uniformly. This is of advantage if difficult panel geometries are intended to be perfectly filled. This is the case in particular in the production of panels for sectional doors.

Both in the case of the symmetrical arrangement and in the case of the unsymmetrical arrangement of the openings b), it is possible to provide an opening b) in the middle of the pipe a), that is to say at the location at which the liquid reaction mixture is fed in. This makes it possible to allow better for the profiling, that is to say the geometrical form of the plates. This is of advantage in particular in the case of roof profiles and in the case of small beads, as on panels for sectional doors. If the reaction mixture is not applied directly to the small beads, problems with substrate defects and/or air inclusions may occur in this area.

If more than one of the openings b) is provided at an angle, it is preferred that the angle increases toward the edge of the outer layer. This allows the pipe a) to be of a narrower construction. This makes it easier to clean. Furthermore, this embodiment allows application over a wider area. If the pipe a) can be adjusted in height in relation to the outer layer, the application width can be varied. The higher the pipe a) is situated, the wider the application. This makes the pipe a) universally usable. The only matter for consideration is the application rate, not so much the application width of the pipe a), since this can be set by the height.

In this respect, the size of the angle of the outer openings b) is preferably determined by the formula

Smaller angle=greater angle/number of openings provided at an angle.

That is to say, in the case of two openings b), the value for the smaller angle is half that of the greater, in the case of three openings b) the value is ⅓ of the greatest angle, in the case of 4 openings b) is ¼ of the greatest angle.

The distance of the openings b) from one another is preferably 2 to 200 mm. In particular embodiments of the invention, the distance between the openings b) that is provided at an angle may be less than 2 mm. Even in this case the distance is normally not less than 1 mm.

The openings b) that are provided at an angle may be provided at the same distance from one another and also from the openings b) that are not provided at an angle.

It is also possible to provide the openings b) that are provided at an angle at the same distance from one another but at a different distance, preferably a smaller distance, than that of the openings b) that are not arranged at an angle.

In this case it is preferred to choose the distance between the openings b) to be all the smaller the greater the angle of the openings b).

The diameters of the openings b) preferably lie in the range between 0.1 and 10 mm. The diameter of the perforations preferably lies between 1 and 6 mm, in particular between 1.5 and 4 mm.

These diameters may remain constant over the entire pipe a). In one particular embodiment of the invention, the diameters of the openings b) may also vary over the extent of the pipe a). This depends in particular on how much foam is required in the individual regions, in particular the edge regions of the outer layers.

In principle, the diameter of the perforations b) may vary over the pipe a) as a whole.

In one embodiment of the invention, the diameter of the openings b) decreases in the direction of the edge of the outer layer. In a further embodiment of the invention, the diameter of the openings b) increases in the direction of the edge of the outer layer. In one embodiment of the invention, the openings b) that are arranged at an angle have a smaller diameter than the others.

In a further preferred embodiment of the invention, the openings b) are designed such that the liquid reaction mixture emerges from each opening at the same rate. This may be achieved, for example, by varying the diameters of the openings b). In a preferred embodiment, this is achieved by varying the length of the openings. The length of the openings is understood as meaning the distance from the inner side of the pipe a) in which the openings b) are provided to the point at which the reaction mixture emerges from the applicator.

In order to achieve a uniform rate of emergence, the length of the openings b) decreases from the feed for the reaction mixture to the end regions of the pipe a).

The length of the openings b) may be varied by the inside diameter of the pipe a) decreasing from the middle to the end regions while the outside diameter is constant. However, this embodiment is difficult in terms of production and is therefore not preferred.

The diameter of the pipe a) is preferably 0.2 to 5 cm.

In one embodiment of the invention, the length of the openings b) may be varied by the pipe a) being modified on the side on which the openings b) are provided in such a way that the openings b) are extended. This embodiment will be discussed in more detail further below.

In one embodiment of the invention, two or more pipes a) may also be used, in particular two pipes a) arranged next to one another. This may be advantageous in particular in the case of very wide outer layers.

The pipe a) may consist of metal. Steel, in particular stainless steel, is preferred here. This embodiment is distinguished by high mechanical stability.

In the case of this embodiment, the length of the openings b) may be varied by welding a flat metal part of an appropriate length and thickness onto the pipe a). The welded-on metal part is adapted in stages to the length of the openings, for example by being milled away. The openings b) are provided, in particular drilled, and then preferably deburred. The device may subsequently also be hardened. For this purpose, other production possibilities are also conceivable.

In the course of the operation of the devices, soiling by reaction products occurs. Therefore, the device must be regularly cleaned, in particular by rinsing with a solvent.

In another embodiment of the invention, the pipe a) consists of plastic. Thermoplastics are preferred here. For safety reasons, it should be ensured that the plastic does not become electrostatically charged, since hydrocarbons, which are flammable, are often used as a foaming agent in the production of foams.

The plastic may preferably be a polyamide or a polyoxymethylene (POM), in particular a polyamide. In order to improve the mechanical stability, the plastic may be reinforced by fillers. One example of this is glassfiber-reinforced polyamide.

The pipes a) consisting of plastic are preferably produced by injection molding.

When plastic is used, there is a reduction in weight in comparison with the use of metal. Furthermore, it costs less to produce large numbers. When the device is soiled, it can be disposed of and replaced with a new device.

In one embodiment of the invention, at least two pipes a) provided with openings b), arranged in particular in such a way that they form a straight line, are. Preferably 2 to 4, particularly preferably 2 to 3 and in particular 2 pipes a) are used. If a number of pipes a) are used, the openings b) are provided at an angle only on the side which is located over the edge of the outer layer.

The applicator is preferably provided at a height of 1 to 40 cm, preferably 10 to 30 cm, and in particular 15 to 25 cm over the lower outer layer. The exact distance must be adapted to the profiling of the outer layer and may therefore vary.

The pipes a) or the pipes arranged next to one another may together have a length which is equal to the width of the outer layer. However, this is not preferred, since product can end up alongside the outer layer.

Therefore, the length of the pipe a) is preferably less than the width of the outer layer, in order to be on the safe side. In this case, the pipe a) is arranged centrally over the outer layer. The casting rake preferably covers at least 60, in particular 70%, of the width of the outer layer. With a width of the outer layer of 1.20 m, as is usual in the case of sandwich elements, a width of 18 cm on each side would in this case not be covered by the casting rake. Preferably, the casting rake or the casting rakes arranged next to one another cover at least 60, in particular at least 70%, of the width of the outer layer. On account of the perforations b) provided at an angle, it is possible to reduce the length of the pipe a) in comparison with those on which no perforations b) are provided.

The liquid reaction mixtures are preferably those for producing isocyanate-based foams, in particular polyurethane and polyisocyanurate foams. As is generally known, these are produced by reacting polyisocyanates with compounds having at least two hydrogen atoms that are reactive with isocyanate groups in the presence of foaming agents. The components are mixed in a customary mixing device, for example a high-pressure or low-pressure mixing head, and fed to the pipe a).

This usually takes place by means of a connection provided between the mixing device and the pipe a). This connection preferably takes the form of a pipe; in the case of the use of a number of pipes, each is connected to the feed. This may take place through a pipe from which in turn there extend connecting pipes to the pipes.

The diameter of the feeds is preferably constant. It is dependent on the required amount of reaction mixture. The diameter preferably lies between 4 and 30 mm, particularly preferably between 6 and 22 mm.

The applicator according to the invention is preferably designed such that the rate of liquid starting material for the isocyanate-based rigid foam that is applied to the outer layer is between 2 kg/min and 100 kg/min, preferably between 8 kg/min and 60 kg/min and in particular between 4 kg/min and 50 kg/min.

The viscosity of the liquid starting material for the isocyanate-based rigid foam at 25° C. preferably lies between 50 mPa*s and 2000 mPa*s, particularly preferably between 100 mPa*s and 1000 mPa*s.

Flexible or rigid, preferably rigid, outer layers, such as plasterboard panels, glass mats, aluminum foils, aluminum, copper or steel plates, preferably aluminum foils, aluminum or steel plates, particularly preferably steel plates, may be used as the outer layer. The steel plates may be coated or uncoated. The steel plates may be pretreated, for example by corona, arc or plasma treatment or other customary methods.

The outer layer is preferably transported at a constant rate of 1 to 60 m/min, preferably 2 to 150 m/min, preferably 2 to 50 m/min, particularly preferably 2.5 to 30 m/min and in particular 2.5 to 20 m/min. At the same time, the outer layer is in a horizontal position, at least from when the foam system is applied, preferably during the entire time from when the adhesion promoter is applied.

When plates and foils are used as outer layers, in the process according to the invention the outer layers are uncoiled one after the other from a roll, optionally profiled, heated and optionally pretreated in order to increase their acceptance of polyurethane foam, the adhesion promoter is optionally applied, they are provided with the starting material for the isocyanate-based rigid foam a) by means of the upright rake according to the invention, cured in the twin belt and finally cut to the desired length.

The profiling of the outer layers preferably takes place by means of metal rollers, which profile, edge, bend and/or roll the plate into the desired form.

The usual products may be used as isocyanate-based rigid foams. These are described, for example, in WO 2009/077490.

For better bonding of the isocyanate-based rigid foams, an adhesion promoter, preferably based on polyurethane, may be located between the outer layer and the foam. This adhesion promoter may be applied in a customary and known way. In an advantageous embodiment of the invention, the application of the adhesion promoter takes place by means of a rotating disk. Such a method is described, for example, in WO 2006/029786.

The applicators according to the invention have a series of advantages.

With the applicators of the prior art there was the problem that, when the outer layers have pronounced profilings and the material distribution is not adjusted appropriately for them, defects may occur when the reaction mixture is applied to the outer layer. These defects may later lead to blisters on the resultant composite elements and are therefore undesired.

Previously, the reaction mixture was deposited at the point closest to the profiling and the foam had to be pushed into the profiling. This resulted in a foam with poorer mechanical properties in the profiling. In particular, the compressive strengths of the foams pushed into the profiling are much less than in the other regions of the composite element.

Arranging the outer openings b) at an angle allows liquid reaction mixture to get into this region and foam there. This produces a homogeneous combination of properties of the foam throughout the composite element.

An optimized distribution (the material is applied where it is required—non-uniform discharges of material may be desired here) allows problems such as substrate defects and pushing zones/regions to be eliminated.

The subject matter of the present invention is accordingly also a method for producing composite elements comprising the application of liquid reaction mixtures to an outer layer by means of an applicator, the outer layer being continuously moved, the liquid reaction mixture being applied to the outer layer and the device according to the invention being used as the applicator.

The subject matter of the present invention is consequently also the use of the device according to the invention for applying liquid reaction mixtures to an outer layer and for producing composite elements.

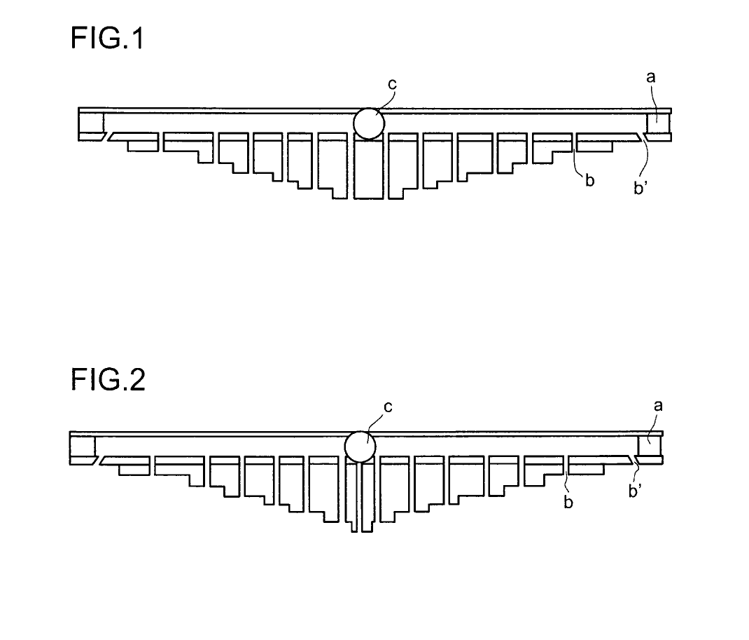

The invention is described in more detail in FIGS. 1 to 4.

In all the figures, a) denotes the pipe a), b) denotes the straight openings b), b′ denotes the openings b) that are arranged at an angle and c) denotes the feed for the reaction mixture. It can be seen in all the figures that the length of the openings b) decreases toward the outside.

FIG. 1 shows a symmetrically designed applicator with a respective opening b) arranged at an angle.

FIG. 2 shows the same arrangement as FIG. 1, a perforation b) being additionally provided in the middle, below the feed for the reaction mixture.

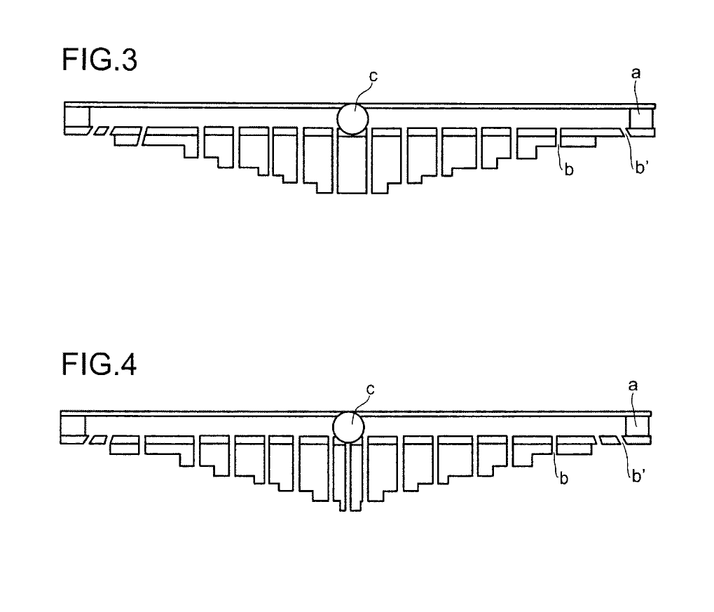

FIG. 3 shows an unsymmetrically designed applicator with one opening b) arranged at an angle on one side and three openings b) arranged at an angle on the other side.

FIG. 4 shows a symmetrically designed applicator with two respective openings b) arranged at an angle.

1. A method for producing composite elements, the method comprising:
applying a liquid reaction mixture to an outer layer with an applicator; and
continuously moving the outer layer,
wherein the applicator comprises a pipe with openings in a direction of the outer layer,
the pipe is above the outer layer parallel to a plane of the outer layer and at right angles to a direction of movement of the outer layer, and
the outer 1 to 4 openings are above an edge of the outer layer at an angle of from 1 to 50° in a direction of the edge of the outer layer.

2. (canceled)

3. The method according to claim 1, wherein the size of the angle of the openings increases in the direction of the edge of the outer layer.

4. The method according to claim 1, wherein the size of the angle of the outer openings is determined by formula:
smaller angle=greater angle/number of openings at an angle.

5. The method according to claim 1, wherein the pipe is immovably arranged.

6. The method according to claim 1, wherein the openings are designed such that the liquid reaction mixture emerges from all of the openings at the same rate.

7. The method according to claim 1, wherein a diameter of the openings decreases from a feed for the liquid reaction mixture to end regions of the pipe.

8. The method according to claim 1, wherein a length of the openings decreases from a feed for the liquid reaction mixture to end regions of the pipe.

9. The method according to claim 1, wherein the pipe reaches over at least 60% of the width of the outer layer.

10. The method according to claim 1, wherein the pipe is at a height of from 1 to 40 cm above the outer layer.

11. The method according to claim 1, wherein a feed for the liquid reaction mixture is in the middle of the pipe.

12. The method according to claim 1, wherein a diameter of the pipe is from 0.2 to 5 cm.

13. The device according to claim 1, wherein a diameter of the openings is from 0.1 to 10 mm.

14. The method according to claim 1, wherein a distance between the openings is from 2 to 200 mm.

15. The method according to claim 1, wherein a distance between the openings at an angle of from 1 to 50° in a direction of the edge of the outer layer becomes less from the middle to the end regions.

16. The method according to claim 1, wherein the pipe comprises metal.

17. The method according to claim 1, wherein the pipe comprises plastic.

18. The method according to claim 1, wherein the applicator comprises two pipes arranged next to one another.

19-21. (canceled)
